(19) United States
(12) Patent Application Publication
(10) Pub. No.: US 2002/0096541 A1
(43) Pub. Date: Jul. 25, 2002

(54) Applicator

(75) Inventor: Ian Cross, Oxfordshire (GB)

Correspondence Address: YOUNG & THOMPSON, 745 SOUTH 23RD STREET 2ND FLOOR, ARLINGTON, VA, 22202

(73) Assignee: Ambic Equipment Limited

(21) Appl. No.: 09/983,710

(22) Filed: Oct. 25, 2001

(30) Foreign Application Priority Data
Jan. 20, 2001 (GB) 0101550.2

(51) Int. Cl. A01J 7/04; B67D 5/06

(52) U.S. Cl. 222/190; 222/205; 119/670; 119/673

(57) ABSTRACT

The applicator comprises a container for containing a liquid including a foaming agent, a cup mounted on the container, means for supplying gas at an elevated pressure into the liquid in the container to cause the liquid to foam and passage means between the container and the cup and through which foam can pass from the container to the cup.

### INTRODUCTION

This invention relates to an applicator for treating the teats of animals, typically cows, such as with a disinfectant.

It is known to provide applicators for treating the teats of animals, typically cows, with a liquid disinfectant immediately prior to and/or immediately after milking. Some known applicators comprise a compressible container and a rigid cup threadably engaged with the open end of the container. The cup of known applicators is frustoconical and has an opening in its base. Liquid in the container can be discharged through the opening into the cup by compressing the container and, whilst holding the container in the compressed state, the cup can be placed over teats to dip the teats in the disinfectant. The liquid will return to the container when the container is no longer held in a compressed condition.

These known applicators work quite satisfactorily but there are conceived advantages in dipping the teats in a foam rather than a liquid. Firstly, foam is more visible to the eye than liquid and, therefore, the use of foam will provide a user with visible confirmation that all teats have been dipped. Also, it is thought that by using foam, less disinfectant will be used. Foam may also have a greater residue on the teat of its active ingredients, which will therefore remain on the teat for a longer period of time. Other versions include a non return system that prevents used chemical returning to the container.

It is known from GB-A-2299011 to provide an applicator comprising a compressible container for containing a liquid including a foaming agent, a cup mounted on the container, foaming means for drawing air into liquid in the container as the container expands from a compressed state to cause the liquid to foam, and passage means between the container and the cup and through which foam can pass from the container to the cup as the container is compressed. This however suffers from the drawback that the operator has to continually squeeze the container to produce sufficient foam to dip each teat. Herd sizes are increasing making hand squeezing more onerous.

### SUMMARY OF THE INVENTION

According to the present invention, there is provided an applicator comprising a container for containing a liquid including a foaming agent, a cup mounted on the container, means for supplying gas at an elevated pressure into liquid in the container to cause the liquid to foam and passage means between the container and the cup and through which foam can pass from the container to the cup.

Preferred and/or optional features of the invention are set forth in claims 2 to 9 inclusive.

The invention will now be more particularly described, by way of example, with reference to the accompanying drawings.

### BRIEF DESCRIPTION OF THE DRAWINGS

FIG. 1 is a schematic view of a foaming system including three applicators embodying the present invention,

FIG. 2 is a side view of one of the applicators shown in FIG. 1, and

FIG. 3 is a sectional view of part of one of the applicators shown in FIG. 2.

### DESCRIPTION OF THE PREFERRED EMBODIMENT

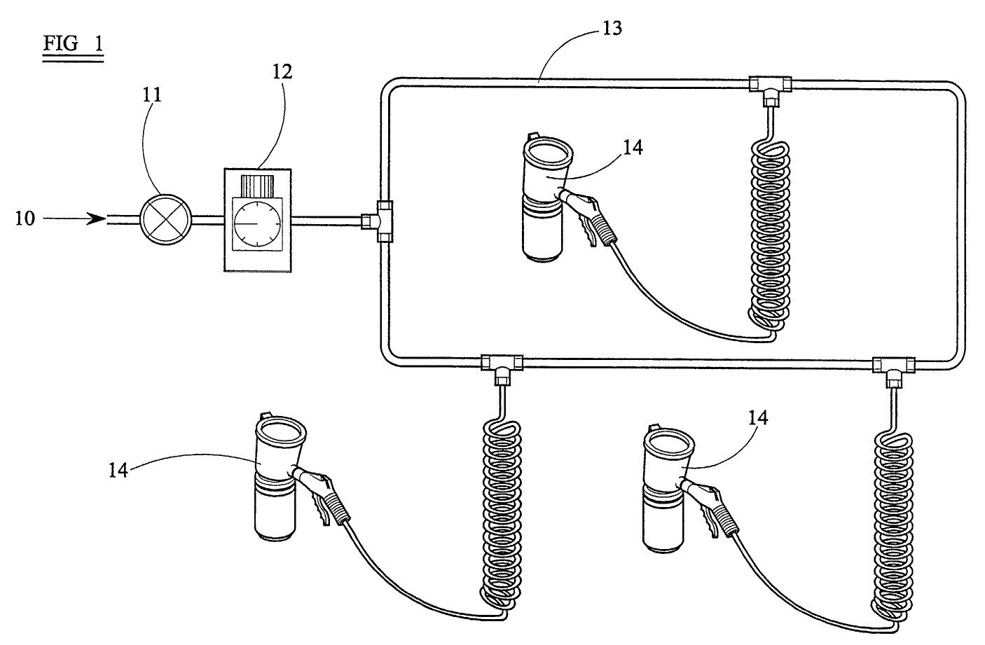

Referring firstly to FIG. 1, there is shown therein a foaming system comprising a source of compressed gas, typically air, 10, a shut off valve 11, a pressure regulator 12 for reducing the pressure from the compressed gas source 10 to 3 to 6 p.s.i. and pipework 13 connecting the gas source 10, in the example shown, to three applicators 14.

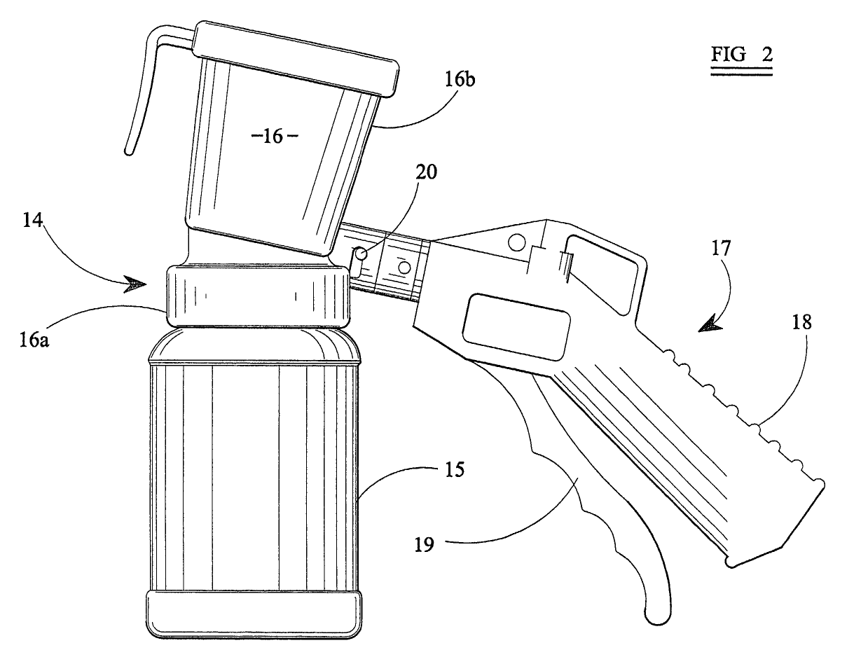

As shown in FIG. 2, each applicator 14 comprises a container, in the form of an open top bottle 15, and a plastics cup 16 which is threadably engaged with the open upper end of the bottle 15.

The cup 16 has a generally cylindrical base portion 16a which threadably engages with the open end of the bottle 15 and an upper, generally frustoconical portion 16 b which is inclined at a small angle with respect to the base portion 16a. The applicator also comprises a gun 17 having a body part 18 and a manually operable trigger 19 which is operable to open and close a valve in the body part 18 of the gun. The gun 17 is releasably connected to the cup 16 by a bayonet fixing 20.

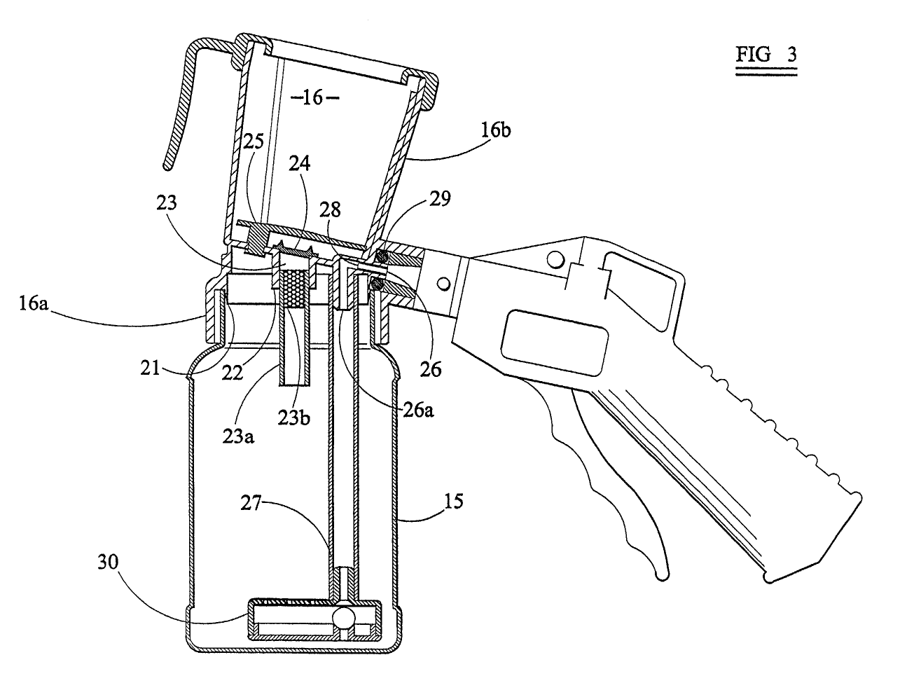

As shown in FIG. 3, the base portion 16a of the cup has an internal annular flange 21 which fits inside the upper externally threaded portion of the bottle 15 to give the connection between the bottle and the cup added rigidity. The base portion 16a of the cup also has a depending central collar 22 which defines an opening 23. A short tube 23a is fitted in the opening 23 and projects downwards into the bottle. A diffuser 23b may be located in the upper end of the tube 23a. This diffuser regulates the size of bubbles produced as foam. A valve member 24 seats against the upper end of the opening 23 and has a boss that locates into that opening. An apertured disc 25 is snap fittably engaged with the base portion 16a and this disc serves to limit upward displacement of the valve member 24 away from its seated position and to evenly distribute foam into the cup.

A gas inlet 26 is moulded into the side wall of the cup 16, emerging in the centre of the bayonet fitting 20. A plastics restrictor 28 is provided in the gas inlet 26 to regulate the volume of gas entering the applicator. Sealed communication with the gun 17 is effected by means of an “O” ring 29. A spigot 26a projects downwards between the annular flange 21 and the collar 22.

A flexible tube 27 is connected to the spigot 26a permitting gas from the inlet 26 to be directed to the bottom of the bottle. A moulded foaming head 30 is connected to the lower end of the tube 27 and comprises a non return valve and a series of fine holes.

In use, the bottle 15 is partially filled with a liquid, typically a liquid disinfectant, containing a foaming agent. In order to cause the liquid to foam up, the trigger 19 of the gun 17 is compressed to allow gas at an elevated pressure to enter the bottle via the foaming head 30 and into the liquid through the fine holes of the foaming head so producing bubbles in the liquid and foam above its top level. This foam passes up through the tube 23a, through the diffuser 23b, past the valve member 24 which is unseated and through the apertures in the disc 25. The valve member 24 prevents the return of foam to the bottle and the foam therefore collects within the cup 16. After sufficient foam has been collected in the cup, the cup can be placed over teats so that the teats are disinfected by the foam.

The embodiment described above is given by way of example only and various modifications will be apparent to persons skilled in the art without departing from the scope of the invention.

1. An applicator comprising a container for containing a liquid including a foaming agent, a cup mounted on the container, means for supplying gas at an elevated pressure into liquid in the container to cause the liquid to foam and passage means between the container and the cup and through which foam can pass from the container to the cup.

2. An applicator as claimed in claim 1, wherein the gas supplying means includes manually operable valve means located externally of the cup.

3. An applicator as claimed in claim 2, wherein the valve means are part of a gun.

4. An applicator as claimed in claim 2, wherein the valve means are releasably connected to the cup and wherein the cup has an inlet passage communicating between the valve means and a tube extending into the container.

5. An applicator as claimed in claim 4, wherein the valve means are connected to the cup by a bayonet fixing.

6. An applicator as claimed in claim 1, wherein the passage means between the container and the cup include means at least restricting the return of foam from the cup to the container.

7. An applicator as claimed in claim 6, wherein the restricting means comprises a one way valve.

8. An applicator cup as claimed in claim 1, wherein the cup is releasably connected to the container.

9. An applicator comprising a container for containing a liquid including a foaming agent, a cup mounted on the container, means for supplying gas at an elevated pressure into liquid in the container to cause the liquid to foam and passage means between the container and the cup and through which foam can pass from the container to the cup in combination with a source of gas at an elevated pressure and pressure regulating means for regulating the pressure of gas supplied into liquid in the container.
